(19) United States
(12) Patent Application Publication
(10) Pub. No.: US 2008/0004818 A1
(43) Pub. Date: Jan. 3, 2008

(54) System for Monitoring and Managing Patient Fluid Input and Output

(75) Inventor: John R. Zaleski, Elkton, MD (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS HEALTH SERVICES CORPORATION, MALVERN, PA (US)

(21) Appl. No.: 11/621,628

(22) Filed: Jan. 10, 2007

Related U.S. Application Data
(60) Provisional application No. 60/777,085, filed on Feb. 27, 2006.

(51) Int. Cl. G01F 22/00; G06F 19/00; G06F 3/01; G06F 3/14

(52) U.S. Cl. 702/50; 715/700; 715/719

(57) ABSTRACT

A fluid intake and output viewer application and user interface automatically records patient fluid intake and output data to support fluid balance calculations and data display. A patient fluid parameter user interface and processing system includes a context processor for receiving patient identification information from an executable application. An acquisition processor automatically acquires fluid parameters of a particular patient identified by the received patient identification information. A display processor automatically initiates generation of a composite display image including fluid data updated using the automatically acquired fluid parameters to present both graphical and text indication of patient fluid input and output values and rates of patient fluid input and output, together with the patient identification information.

This is a non-provisional application of provisional application Ser. No. 60/777,085 by J. R. Zaleski et al. filed Feb. 27, 2006.

### FIELD OF THE INVENTION

This invention concerns a patient fluid parameter user interface and processing system providing graphical and text indication of patient fluid input and output volume values and associated flow rates.

### BACKGROUND OF THE INVENTION

Known patient fluid intake and output monitoring systems typically require a healthcare worker to manually navigate and scroll through tables of data and numbers to determine patient cumulative fluid intake and output occurring during a particular time period. Known systems fail to provide seamless initiation of a patient fluid monitoring executable application and fail to provide a user friendly interface presenting a comprehensive overview of patient fluid intake and output in a single display image without requiring cumbersome user navigation to derive or locate desired information. In addition known systems lack integration with a hospital or clinical information system and lack the associated interfaces that support real-time update of patient fluid balance data, for example, and support automated update of a patient record and concurrent access by multiple clinicians to patient fluid balance data. A system according to invention principles addresses these deficiencies, needs and related problems.

### SUMMARY OF THE INVENTION

A fluid intake and output viewer application and user interface automatically records patient fluid (e.g., blood, urine) intake and output data to support fluid balance calculations and enables a clinician to remotely review and validate the data via a user friendly display interface employing visual icons to simplify data presentation. A patient fluid parameter user interface and processing system includes a context processor for receiving patient identification information from an executable application. An acquisition processor automatically acquires fluid parameters of a particular patient identified by the received patient identification information. A display processor automatically initiates generation of a composite display image including fluid data updated using the automatically acquired fluid parameters to present both graphical and text indication of patient fluid input and output values and rates of patient fluid input and output, together with the patient identification information.

### BRIEF DESCRIPTION OF THE DRAWING

FIG. 1 shows a Hospital Information System (HIS) including a patient fluid parameter user interface and processing system, according to invention principles.

FIG. 2 shows a user interface display image provided by a patient fluid parameter user interface and processing system, according to invention principles.

FIG. 3 shows a flowchart of a process performed by a patient fluid parameter user interface and processing system, according to invention principles.

### DETAILED DESCRIPTION OF THE INVENTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprises any combination of, hardware, firmware, and/or software.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UI), as used herein, comprises one or more display images, generated by a display processor enabling user interaction with a processor or other device and associated data acquisition and processing functions. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of the executable procedure or executable application manipulates the UI display images in response to the signals received from the input devices. In this way, the user interacts with the display image using the input devices, enabling user interaction with a processor or other device. A workflow processor initiates and manages a sequence of tasks for performance by a worker, device or both. The workflow processor provides data representing a task list of one or more workers and updates and manages the task list. The functions and process steps herein may be performed automatically or wholly or partially in response to user command. An activity performed automatically is performed in response to executable instruction or device operation without direct user initiation of the activity.

A system according to invention principles generates a composite display image presenting comprehensive patient fluid data providing a user with a single at-a-glance perspective of patient fluid intake and output without requiring a the user to navigate and scroll through numbers or tables of data. The system includes a user interface that displays real-time fluid intake, output and balance data derived from data acquired from a patient within a medical or surgical recovery care unit, for example. A user interface provides a display image incorporating comprehensive patient fluid data accessible via a menu tab in a medical device integration engine image, for example. The user interface is advantageously seamlessly initiated using associated patient and user context information provided by a calling application within an existing healthcare information system such as a Clinical Information System, for example.

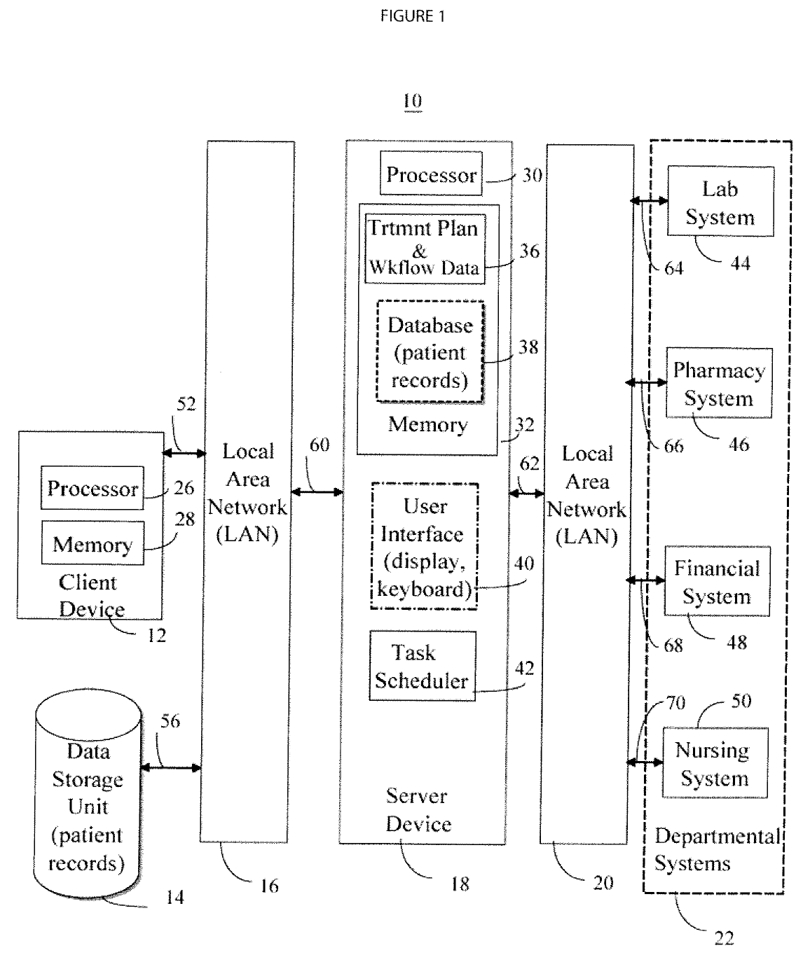

FIG. 1 shows a Hospital Information System (HIS) 10 including user interface system 40 for adaptively presenting information to a user. Healthcare information system 10 includes a client device 12, a data storage unit 14, a first local area network (LAN) 16, a server device 18, a second local area network (LAN) 20, and departmental systems 22. The client device 12 includes processor 26 and memory unit 28 and may comprise a personal computer, for example. The healthcare information system 10 is used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. Examples of the people being serviced by the healthcare provider include, without limitation, a patient, a resident, and a client.

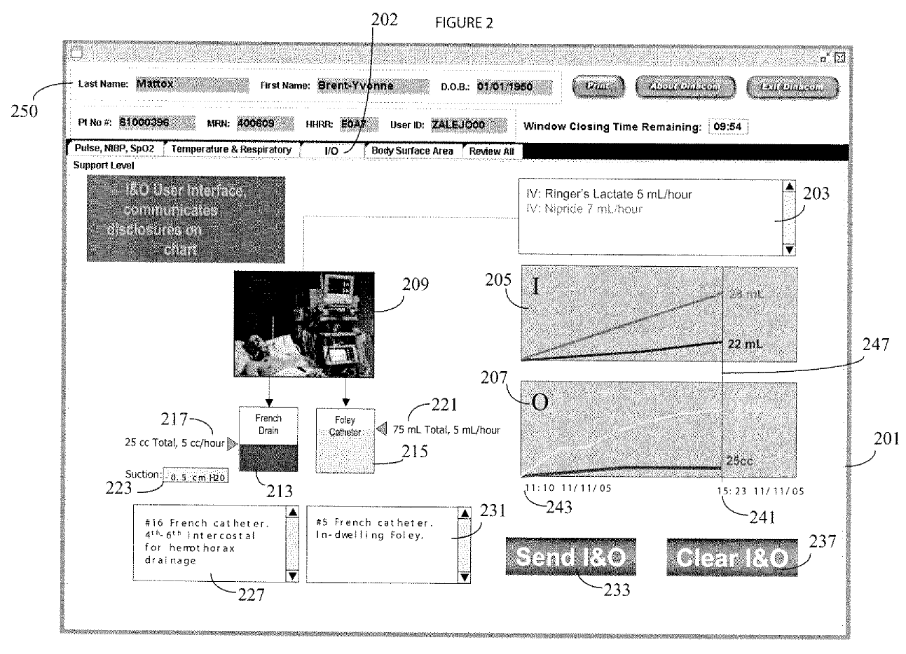

User interface system 40 in server 18 provides an image display including patient fluid intake, output and balance data (e.g., as illustrated in FIG. 2). Server device 18 permits multiple users to access user interface images including patient fluid intake, output and balance data, at multiple client devices. A context processor in user interface 40 receives patient identification information from an executable application such as a Clinical Information System. An acquisition processor in unit 40 automatically acquires fluid parameters of a particular patient identified by the received patient identification information. A user interface 40 display processor automatically initiates generation of an updated composite display image using the automatically acquired fluid parameters to present both graphical and text indication of patient fluid input and output values and rates of patient fluid input and output, together with the patient identification information. In another embodiment user interface system 40 is located in client device 12.

User interface system 40 includes an input device that permits a user to provide information to client device 12 and an output device that provides a user a display of user interface images including patient fluid intake, output and balance data. Preferably, the input device is a keyboard and mouse, but also may be a touch screen or a microphone with a voice recognition program, for example. The output device provides information to the user responsive to the input device receiving information from the user or responsive to other activity by client device 12. For example, the display presents information responsive to the user entering information in the client device 12 via a keyboard.

FIG. 2 shows a user interface composite display image 201 provided by a patient fluid parameter user interface and processing system 40. User interface 40 provides the linkages and display images (including composite display image 201) to support a larger healthcare information system. User interface display image 201 is presented in response to user selection of I/O tab 202 (e.g., a tab implemented using Java code) within a Medical Device Integration Engine user interface. A scrolling image pane 203 indicates a current intravenous fluid administration rate to a patient identified in row 250. Patient intravenous fluids comprising intake fluids are shown cumulatively in graphical plot 205 together with movable crosshair 247 that is movable by clicking on it and dragging it with a mouse left or right. Plot 205 illustrates a point of intersection between the cross-hair and two different cumulative fluid intake graph lines. The intersection point is selected by dragging the cross-hair and on one graph line indicates a value “28 mL” as the amount of that particular fluid delivered at the time indicated on the associated time and date stamp point 241 along the abscissa. The intersection point on the second graph line indicates a value “22 mL” at plot point 241. The left-hand most point 243 of plot 205 and cumulative fluid output graphical plot 207 (having a common x axis) is the time and date at which the intravenous fluid administration was started.

Patient cumulative fluid output is illustrated in one graph line and corresponding instantaneous fluid volume output in a second graph line in graph plot 207. Also, the patient concerned identified in row 250 is shown in real time video in video image window 209. Display image 201 also automatically presents fluid information associated with catheters and IV infusion associated with the patient. Picture image element box 213 indicates patient fluid output volume derived from a chest tube (a “French Drain”). Picture image element box 215 indicates patient fluid output volume derived from a urinary catheter. Boxes 213 and 215 graphically identity catheter and IV bags and the proportion of image element box shading indicates the fluid volume contained within the catheter bags or bottles. Movable sliders items 217 and 221 graphically associate fluid volume levels with data indicating fluid volume totals (cumulative total fluid volume) and rate of fluid release into respective containers. Text field 223 indicates associated chest tube suction. Scrollable text panes 227 and 231 enable a user to add notes to the data. Text notes in panes 227 and 231 are transmitted along with current data for incorporation in a patient medical record in response to user selection of button 233 (“Send I&O” button). Further, in response to user selection of button 237 (“Clear I&O”), text is deleted from scroll panes 227 and 231, graphical plots 205 and 207 are cleared, and container representative image element boxes 213 and 215 are emptied and associated data is reset. In addition, the fluid recording indicated in graphical plots 205 and 207 and image element boxes 213 and 215 and associated data, restarts from zero.

User interface 40 dynamically provides display images including display image 201 and automatically and continuously updates the images without requiring user intervention to initiate updates. User interface 40 and associated display images are launched as a child application (e.g. of a CCOW (Common Context Object Working Group of HealthLevel7 (HL7)) compliant Global Session Management (GSM) application from a parent Healthcare Information System HIS and acquires context information of a patient, and application specific context information from a parent patient census application, for example. Healthcare information system (HIS) 10 advantageously integrates user interface 40 and associated data with existing HIS and medication administration systems. In an HIS employing GSM context management, for example, information displayed is advantageously dynamically linked with patient context information automatically (with or without use of HL7 protocol), and a medication administration system provides data back to the HIS.

Composite display image 201 provides a visual representation of fluid output from a patient that enables a nurse to assess a need for catheter and bag replacement and to evaluate whether drainage rates are compatible with treatment protocol guidelines. User interface 40 also automatically generates a message for communication to a worker in response to determination of excessive fluid input or output rates (i.e. rates exceed predetermined thresholds). Picture image element boxes 213 and 215 in display image 201 provide a visualization of patient blood drainage and urinary output via virtual “beakers”. Movable sliders items 217 and 221 comprise floating pointers showing a value next to each beaker to indicate quantitatively (volume) and qualitatively (“fullness” of beaker) as well as the volume and rate of fluid output. Display image 201 advantageously presents real-time graphical plots of fluid volume totals and rates of output next to beakers to depict a patient fluid status time history within the eye span of a clinician. Display image 201 includes patient identification information on row 250 to prevent association of the fluid data with the wrong patient. User interface 40 and display image 201 enables a nurse to validate fluid data and user entered text notes in real-time and send data to a patient medical record via a single command.

Returning to FIG. 1, server device 18 generally includes processor 30, a memory unit 32 including workflow data and a treatment plan 36 and a database 38 containing patient records. Server device 18 also includes Rules Engine and Workflow Engine (task scheduler 42). Server device 18 may be implemented as a personal computer or a workstation. Database 38 provides a location for storing patient records and data storage unit 14 provides an alternate store for patient records, as well as other information for hospital information system 10. The information in data storage unit 14 and database 38 is accessed by user interface 40 for presenting information using an expandable image element box. Alternatively, patient records may be accessed from memory unit 28 in client device 12, or in memory units in the departmental systems 22. Patient records in data storage unit 14 include information related to a patient including, without limitation, biographical, financial, clinical, workflow, care plan and patient encounter (visit) related information.

The communication paths 52, 56, 60, 62, 64, 66, 68 and 70 permit the various elements, shown in FIG. 1, to communicate with the first LAN 16 or the second LAN 20. Each of the communication paths 52, 56, 60, 62, 64, 66, 68 and 70 are preferably adapted to use one or more data formats, otherwise called protocols, depending on the type and/or configuration of the various elements in the healthcare information systems 10. Examples of the information system data formats include, without limitation, an RS232 protocol, an Ethernet protocol, a Medical Interface Bus (MIB) compatible protocol, DICOM protocol, an Internet Protocol (I.P.) data format, a local area network (LAN) protocol, a wide area network (WAN) protocol, an IEEE bus compatible protocol, and a Health Level Seven (HL7) protocol.

Departmental systems 22 are systems that need access to information or provide information related to the health and/or welfare of patients in the care of the healthcare provider. Examples of the departmental systems 22 include, a lab system 44, a pharmacy system 46, a financial system 48 and a nursing system 50, as shown in FIG. 1, but may also include a records system, a radiology system, an accounting system, a billing system, and any other system required or desired in a healthcare information system.

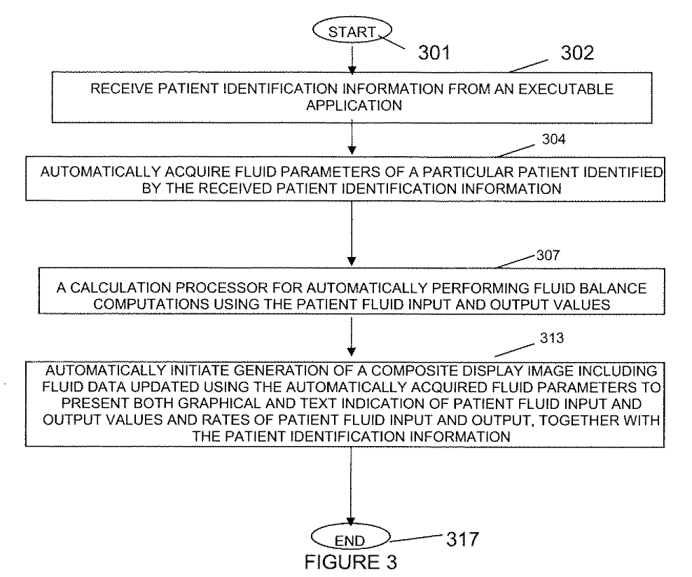

FIG. 3 shows a flowchart of a process performed by a patient fluid parameter user interface and processing system. In step 302 following the start at step 301 a context processor in unit 40 receives patient identification information from an executable application. An acquisition processor in unit 40 in step 304 automatically electronically acquires fluid parameters of a particular patient identified by the received patient identification information from, patient attached devices, a patient parameter monitoring system and a medication administration system. A calculation processor in unit 40 in step 307 automatically performs fluid balance computations determining cumulative fluid input and output and the difference thereof for a particular patient in a predetermined time period using acquired patient fluid input and output values.

A display processor in unit 40 in step 313 automatically initiates generation of a composite display image including fluid data updated using the automatically acquired fluid parameters to present both graphical and text indication of patient fluid input and output values, cumulative total patient fluid (e.g., IV infusion) input, cumulative total patient fluid output via a catheter, fluid balance data and rates of patient fluid input and output. This is presented together with the patient identification information and corresponding graphical indicators showing a vessel and indicating proportion of fullness of the vessel and movable fluid level together with a total fluid volume associated with the fluid level. The graphical indicators include movable items graphically associating fluid volume levels with data indicating cumulative total fluid volume and rate of fluid release into a vessel. The display processor automatically includes information in the composite display image, identifying, a type of catheter, a type of IV bag, an Intra-Venous (IV) fluid, used by the particular patient and a window including a real time video display of the particular patient. The composite display image also includes an image window enabling a user to add notes to patient fluid data.

The composite display image includes a user selectable button enabling a user to initiate communication of at least two of, (a) cumulative patient fluid input volume, (b) cumulative patient fluid output volume, (c) rates of patient fluid input and output and (d) user entered text associated with patient fluid data, to a patient medical record for storage. The composite display image also includes a user selectable button for initiating, deletion of text associated with patient fluid data entered by a user via the composite display image and resetting cumulative patient fluid input or output volume graphs to restart from zero. The process of FIG. 3 terminates at step 317.

The system, process and image menu of FIGS. 1-3 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A patient fluid parameter user interface and processing system according to invention principles is usable for medical, emergency, and surgical wards or units for patients on intravenous lines and urinary catheters and is also useful for patients with chest tube emplacements in the emergency room and post-operatively to verify and accurately measure chest tube drainage, for example. Further, any of the functions and steps provided in FIGS. 1 and 3 may be implemented in hardware, software or a combination of both and may reside on one or more processing devices located at any location of a network linking the FIG. 1 elements or another linked network including another intra-net or the Internet.

What is claimed is:

1. A patient fluid parameter user interface and processing system, comprising:
a context processor for receiving patient identification information from an executable application;
an acquisition processor for automatically acquiring fluid parameters of a particular patient identified by said received patient identification information; and
a display processor for automatically initiating generation of a composite display image including fluid data updated using said automatically acquired fluid parameters to present both graphical and text indication of patient fluid input and output values and rates of patient fluid input and output, together with said patient identification information.

2. A system according to claim 1, wherein
said composite display image presents at least one of, (a) cumulative total patient fluid input and (b) cumulative total patient fluid output, using corresponding graphical indications indicating proportion of fullness of a vessel.

3. A system according to claim 2, wherein
said graphical indications indicating proportion of vessel fullness graphically show a vessel and movable fluid level together with a total fluid volume associated with said fluid level.

4. A system according to claim 2, wherein
said display processor automatically includes cumulative total patient fluid IV infusion input and cumulative total patient fluid output via a catheter.

5. A system according to claim 3, wherein
said graphical indications include movable items graphically associating fluid volume levels with data indicating cumulative total fluid volume and rate of fluid release into a vessel.

6. A system according to claim 4, wherein
said display processor automatically includes information in said composite display image, identifying at least one of, (a) a type of catheter and (b) a type of IV bag.

7. A system according to claim 1, wherein
said composite display image presents cumulative total patient fluid input and output, using corresponding graphical indications indicating proportion of vessel fullness.

8. A system according to claim 1, wherein
said composite display image includes information identifying at least one of, (a) a catheter type and (b) an Intra-Venous (IV) fluid, used by said particular patient.

9. A system according to claim 1, including
a calculation processor for automatically performing fluid balance computations using said patient fluid input and output values.

10. A system according to claim 9, wherein
said composite display image includes fluid balance result values of said particular patient.

11. A system according to claim 1, wherein
said composite display image includes a window including a real time video display of said particular patient.

12. A system according to claim. 1, wherein
said composite display image includes an image window enabling a user to add notes to patient fluid data.

13. A system according to claim 1, wherein
said composite display image includes a user selectable button for initiating communication of at least two of, (a) cumulative patient fluid input volume, (b) cumulative patient fluid output volume, (c) rates of patient fluid input and output and (d) user entered text associated with patient fluid data, to a patient medical record for storage.

14. A system according to claim 1, wherein
said composite display image includes a user selectable button for initiating at least one of, (a) deletion of text associated with patient fluid data entered by a user via said composite display image and (b) resetting cumulative patient fluid input or output volume graphs to restart from zero.

15. A system according to claim 1, wherein
said acquisition processor automatically electronically acquires fluid parameters of a particular patient from at least one o f (a) patient attached devices, (b) a patient parameter monitoring system and (c) medication administration system.

16. A patient fluid parameter user interface and processing system, comprising:
a context processor for receiving patient identification information from an executable application;
an acquisition processor for automatically acquiring fluid parameters of a particular patient identified by said received patient identification information; and
a display processor for automatically initiating generation of a composite display image including fluid data updated using said automatically acquired fluid parameters to present both graphical and text indication of patient fluid input and output values, cumulative total patient fluid input, cumulative total patient fluid output and rates of patient fluid input and output, together with said patient identification information.

17. A system according to claim 16, wherein
said composite display image presents said patient fluid input and output values using corresponding graphical indications indicating proportion of fullness of a vessel.

18. A system according to claim 16, including
a calculation processor for automatically performing fluid balance computations using said patient fluid input and output values.

19. A patient fluid parameter user interface and processing system, comprising:
a context processor for receiving patient identification information from an executable application;
an acquisition processor for automatically acquiring fluid parameters of a particular patient identified by said received patient identification information; and
a display processor for automatically initiating generation of a composite display image including fluid data updated using said automatically acquired fluid parameters to present both graphical and text indication of patient fluid input and output values and rates of patient fluid input and output, together with said patient identification information and graphical indicators showing a vessel and indicating proportion of fullness of said vessel and movable fluid level together with a total fluid volume associated with said fluid level.

20. A system according to claim 19, including
a calculation processor for automatically performing fluid balance computations using, said patient fluid input and output values and
said display processor automatically includes information in said composite display image, identifying at least one of, (a) a type of catheter and (b) a type of IV bag.
